(19) United States
(12) Patent Application Publication
(10) Pub. No.: US 2017/0339287 A1
(43) Pub. Date: Nov. 23, 2017

(54) IMAGE TRANSMISSION METHOD AND APPARATUS

(71) Applicant: Beijing Xiaomi Mobile Software Co., Ltd., Beijing (CN)

(72) Inventors: Xuan Ma, Beijing (CN); Dian Fan, Beijing (CN); Xinyan Xing, Beijing (CN); Xiaochuan Feng, Beijing (CN); Haohua Li, Beijing (CN); Junzeng Du, Beijing (CN)

(73) Assignees: Beijing Xiaomi Mobile Software Co., Ltd., Beijing (CN); Xiaomi Inc.

(21) Appl. No.: 15/374,373

(22) Filed: Dec. 9, 2016

(30) Foreign Application Priority Data
May 20, 2016 (CN) 201610341840.3

(51) Int. Cl. H04N 1/00; G06K 9/00; G06F 17/30; G06K 9/62

(52) U.S. Cl. CPC H04N 1/00209; G06K 9/6202; G06K 9/00268; G06F 17/30256; G06F 17/30259; G06F 17/30265

(57) ABSTRACT

The present disclosure relates to an image transmission method and apparatus. In one embodiment, the method includes acquiring an image; automatically extracting personal characteristic information from the image; and automatically sending the image to a terminal device associated with the personal characteristic information. The image is thus automatically transmitted to a recipient having personal characteristics matching that detected from the image without user intervention.

### CROSS-REFERENCE TO RELATED APPLICATIONS

The application is based upon and claims priority to Chinese Patent Application No. 201610341840.3, filed on May 20, 2016, which is incorporated herein by reference in its entirety.

### TECHNICAL FIELD

The present disclosure relates to the technical field of image sharing, and more particularly, to an image transmission method and apparatus.

### BACKGROUND

A camera that implements human face recognition technology locks on a human face in a picture by recognizing facial characteristic information in the picture such as eyes, and mouth and other features of a human face. This enables the camera to automatically take the human face as the primary object to be photographed and in turn automatically adjust the focal length and exposure, in order to ensure clarity of the human face. Technologies for human face recognition have provided speedy and reliable face detection.

At present, such camera-implemented human face recognition technologies are only used in image or picture acquisition and is not utilized further after captured pictures are stored in memory. In order to send a captured picture to someone, a user has to perform cumbersome operations. For example, in order to send a picture, the user may need to open a picture library, look for the picture, select an application for sending the picture, determine a recipient of the picture, and then send the picture. Such procedure is inefficient and user unfriendly.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, an image transmission method is disclosed. The method includes acquiring an image; automatically extracting personal characteristic information from the acquired image; and automatically sending the acquired image to a terminal device associated with the extracted personal characteristic information.

In another embodiment, an image transmission apparatus is disclosed. The apparatus includes a processor; a memory in communication with the processor for storing instructions executable by the processor; wherein the processor, when executing the instructions, is configured to acquire an image; automatically extract personal characteristic information from the acquired image; and automatically send the acquired image to a terminal device associated with the extracted personal characteristic information.

In yet another embodiment, a non-transitory computer-readable storage medium having stored therein instructions is disclosed. The instructions, when executed by a processor of a mobile terminal, causes the mobile terminal to acquire an image; automatically extract personal characteristic information from the acquired image; and automatically send the acquired image to a terminal device associated with the extracted personal characteristic information.

### BRIEF DESCRIPTION OF THE DRAWINGS

The accompanying drawings, which are incorporated into the description and constitute a part thereof, illustrate embodiments consistent with the present disclosure and, together with the description, serve to explain the principles of the present disclosure.

FIG. 1 is a flowchart of an image transmission method according to an exemplary embodiment;

FIG. 2 is a flowchart of an exemplary implementation of step 13 of FIG. 1;

FIG. 3 is a flowchart of an exemplary implementation of step 21 of FIG. 2;

FIG. 4 is a flowchart of another exemplary implementation of step 13 of FIG. 1;

FIG. 5 is a flowchart of an image transmission method according to yet another exemplary embodiment;

FIG. 6 illustrates interactions between a mobile terminal and a server in an image transmission method according to an exemplary embodiment;

FIG. 7 is a block diagram of an image transmission apparatus according to an exemplary embodiment;

FIG. 8 is a block diagram of an implementation of the sending module 73 of FIG. 7;

FIG. 9 is a block diagram showing another implementation of the sending module 73 of FIG. 7;

FIG. 10 is a block diagram showing another implementation of the sending module 73 of FIG. 7;

FIG. 11 is a block diagram of an image transmission apparatus according to an exemplary embodiment;

FIG. 12 is a block diagram of an image transmission apparatus according to another exemplary embodiment; and

FIG. 13 is a block diagram of an image transmission apparatus according to yet another exemplary embodiment.

The above drawings illustrate specific embodiments of the disclosure, which will be described in detail hereinafter. The drawings and description are not intended to limit the scope of the inventive concept in any manner but to explain the concept of the present disclosure to those skilled in the art with reference to the specific embodiments.

### DETAILED DESCRIPTION

Here, exemplary embodiments will be described in detail, examples of which are illustrated in the accompanying drawings. The following description refers to the accompanying drawings in which the same numbers in different figures represent the same or similar elements unless otherwise indicated. The implementations set forth in the following description of exemplary embodiments do not represent all implementations consistent with the present disclosure. Instead, they are merely examples of apparatuses and methods consistent with aspects related to the present disclosure as recited in the appended claims.

The terms used herein are merely for describing a particular embodiment, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where” or “in response to that”.

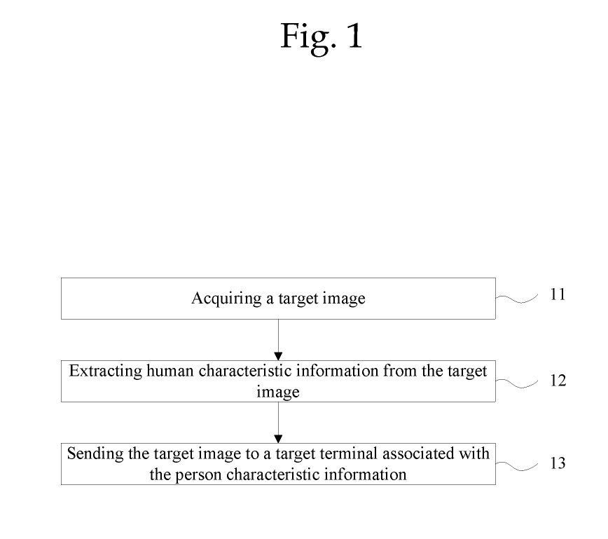

FIG. 1 is a flowchart of an image transmission method according to an exemplary embodiment. The image transmission method may be applied in a mobile terminal or a server. As shown in FIG. 1, the image transmission method may include the following steps.

In step 11, a target image is acquired.

The target image may be acquired through a still image camera, a video camera, a monitoring/surveillance video camera, and so on. These devices are referred to as cameras. A camera may be a built-in device installed in, for example, a mobile terminal. Alternatively, a camera may be a standalone device. The target image may include any content. For example, the target image may contain human characters with specific personal characteristic information. For another example, a target image may contain specific objects. The target image may further contain combination of objects or human characters and with information that may be extracted to represent an event. The embodiment of the present disclosure does not limit the particular content of the acquired target image.

In step 12, personal characteristic information is extracted from the target image.

As an example, in the embodiment of the present disclosure, it is desired that the target image be sent to a target terminal. In one scenario, it may be desired for the camera to send a photo of a person to a terminal device owned by that person appearing in the photo. Therefore, in order to determine whether to send the target image and to determine a recipient of the target image, analysis is made according to the personal characteristic information contained in the target image in this and other various embodiments of the present disclosure. Specifically, it may be first determined whether the target image contains human characteristic information. If the target image does contain personal characteristic information, the personal characteristic information is then extracted.

In step 13, the target image is sent to a target terminal associated with the personal characteristic information.

In one implementation, the mobile terminal or the server stores correspondences between personal characteristic information and target terminals. Therefore, when it is determined that there is a target terminal associated with the detected personal characteristic information, the target image is sent to the target terminal automatically.

As a general description, the image transmission method provided in this embodiment acquires a target image, extracts personal characteristic information from the target image, and directly sends the target image to a target terminal associated with the personal characteristic information. As such, the disclosed solution allows a target image to be sent automatically, which simplifies cumbersome operations for image transmission and effectively improves user convenience and experience.

In one implementation of the image transmission method provided in the above embodiment, step 11 (that is, the step of acquiring the target image) may include: acquiring the target image through an image collection device.

As an example, the image collection device can be a device having a photographing function, such as a still camera, a video camera or a monitoring/surveillance video camera and so on. The image collection device can be an image device independent of the mobile terminal or the server and can also be an image collection device integrated in the mobile terminal or the server.

In the embodiment of the present disclosure, a target image is acquired through an image collection device. Then, personal characteristic information is extracted from the acquired target image so that the target image is sent to a target terminal associated with the personal characteristic information.

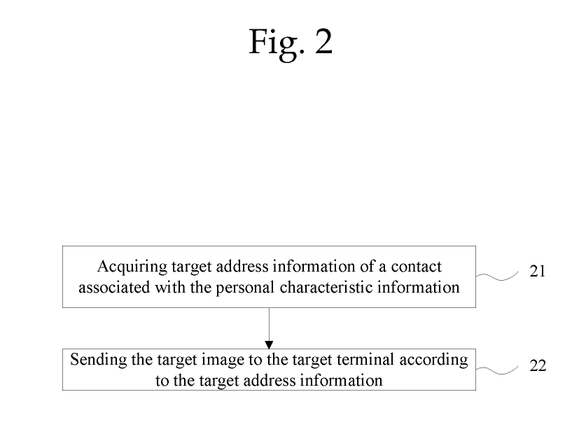

FIG. 2 is a flowchart for an exemplary implementation of the step 13 of FIG. 1. The embodiment of FIG. 2 may be implemented in a mobile terminal or a server. As shown in FIG. 2, the exemplary implementation of the above step 13 may include the following steps.

In step 21, target address information of a contact associated with the personal characteristic information is acquired.

In one implementation, when personal characteristic information is extracted from the target image, a contact database can be searched for target address information of a contact associated with the personal characteristic information, such as email address, QQ number, WeChat account, phone number, social network application account, and so on. This embodiment of the present disclosure does not limit the particular representation of the target address information.

It should be noted that the contact database can be a local contact database or a cloud contact database. The local contact database may be a contact list stored in the memory of the mobile terminal. The memory may to transient or non-transient. The remote contact database may be stored in a cloud account of the user of the mobile terminal. The local contact database and the cloud contact database may coexist. They may be synchronized periodically. This embodiment does not limit where the contact database is applied.

In step 22, the target image is sent to a target terminal according to the target address information.

In this embodiment, after the target address information of a contact associated with the personal characteristic information is acquired, the target image is directly sent to a target terminal corresponding to the target address information. The image may be sent automatically such that the image is distributed to the target terminal belonging to a person appearing in the image without intervention from the user of the mobile terminal.

In summary, the image transmission method provided in the embodiment of FIG. 2 further provides a convenient way to send a target image to a target terminal associated with the personal characteristic information detected in the image. Specifically, target address information of a contact associated with the personal characteristic information is first acquired, and then the target image is sent to a target terminal according to the acquired target address information. Therefore, the solution provided in the embodiments above allows for acquiring target address information and sending a target image to the acquired address. The solution thus automates the step of determining a target terminal associated with personal characteristic information detected in the target image so that the target image can be sent to the corresponding target terminal automatically and with little delay. The application used for sending the target image may be predefined by the user of the mobile terminal. More than one applications may be pre-selected by the user. For example, an email application may be pre-selected for sending the target image when the target address is an email address. Likewise, an instant messaging application may be pre-selected for sending the target image when the target address is an instant messaging account. For example, Wechat application released by Tencent Inc. may be pre-preselected for sending the target image when the target address is a Wechat account ID. The embodiments above thus eliminate the need for user intervention in selecting an image, invoking an application, and determining a target address prior to sending the image by the user, greatly improving user experience and convenience.

In one implementation for the image transmission method above, the personal characteristic information may include at least one of: facial characteristic information, apparel information, personal accessory information, and body figurative characteristic information. The personal characteristic information may alternatively or further include any other characteristic information that may be used to differentiate individuals, such as hairstyle information and so on. These types of information may be used individually or in combination.

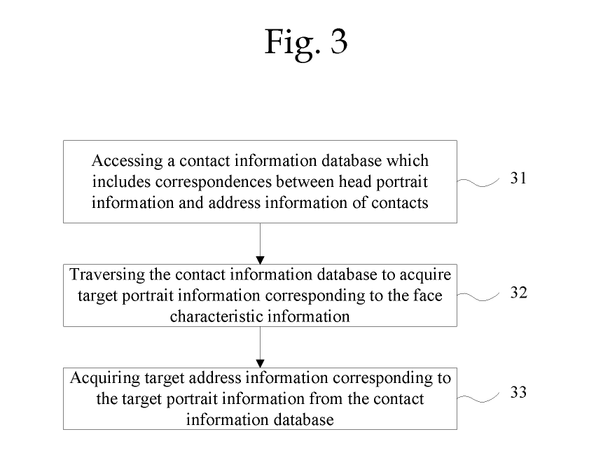

FIG. 3 is a flowchart of an exemplary implementation of step 21 of FIG. 2. The flowchart of FIG. 3 may be applied to a mobile terminal or a server. Without losing generality, facial characteristic information is used as exemplary personal characteristic information in FIG. 3. Thus, the target address in the contact list is identified based on facial characteristic information detected in the target image.

Specifically, in step 31, the contact information database is accessed. The contact information database may, for example, include a portrait and address information corresponding to each contact. The facial characteristic information detected from the target image may, for example include a predefined set of parameters representing an overall facial characteristic such as facial shape and one or more facial features, such as shape, relative size, and position of eyes, nose, and mouth.

In one implementation, whether the image contains human faces may be detected based on, for example, a skin color theory. Specifically, each pixel of the image is described by a set of tri-color values (RGB or YbCbCr, for example). Skin color of a human face under normal natural illumination may generally fall into a skin color range. The actual illumination condition for the image (when the image was acquired) may be estimated from the color composition of the entire image. The skin color range may be adjusted to reflect the estimated illumination condition. For example, if the estimated illumination condition is redder than normal illumination condition, the skin color range may be shifted towards red. The adjusted skin color range may then be used as a basis for detecting whether the image contains a human face (by, for example, searching for patches of pixels having a tri-color values within the adjusted skin color range). Further, the shape of detected patches of pixels having tri-color values falling within the adjusted skin color range may be determined. The shape may be parameterized. Each of these parameters may have a predetermined range that is representative of a human face. These parameters may be referred to as facial characteristic parameters. These parameters determined from the target image may be further analyzed with respect to the predetermined ranges of these facial characteristic parameters to calculate the probability that the patch of pixels with tri-color values falling within the skin color range corresponds to a human face. Determination of these facial characteristic parameters help reduce false human face detection. These parameters representing human facial characteristics may include relative location and shape of facial features. Then, according to the facial characteristic parameter, a contact information database is accessed. The contact information database may contain entries of contacts. Among other data, various contact addresses and portraits associated with each contact may be included in the contact list.

In step 32, the contact information database is traversed to acquire target contact corresponding to the facial characteristics parameters or information.

Since the contact information database includes portraits of the contacts, if the contact information database includes a portrait having facial characteristics corresponding to the detected facial characteristic parameters of the target image, the corresponding contact may be identified.

In one implementation, facial characteristics may be extracted from the portraits within the contact information database. The extracted facial characteristics may be quantitatively compared to the facial characteristic information or parameters extracted from the target image. A contact with a portrait having the closest match may be identified. A facial characteristic threshold may be further predetermined. If the match between the portrait of the identified contact (with the portrait that has the closest match) and the facial characteristic information of the target image is above the predetermined facial characteristic threshold, the mobile terminal or the server may determine that a contact corresponding to the facial characteristic information derived from the target image is found.

Alternatively, facial characteristic information for the portraits may be extracted ahead of time and stored as parameters associated with each contact in the contact information database. As such, the mobile terminal or the server may directly compare the facial characteristic information or parameter derived from the target image to the corresponding facial characteristic information or parameter in the contact information database.

In step 33, target address information of the identified contact having a portrait with facial characteristics corresponding to the detected facial characteristic parameters or information from the target image is acquired from the contact information database.

It should be noted that, as described above, the contact information database includes correspondences between portraits and target address information of the contacts. Therefore, target address information corresponding to the facial characteristics parameters derived from the target image can be acquired directly from the contact information database.

Thus, in the image transmission method provided in the embodiment of the present disclosure, if the personal characteristic information such as facial characteristics information is derived from the target image, a contact having a portrait with facial characteristics corresponding to the derived facial characteristic information may be identified by traversing the contact information database which includes correspondences between portraits and address information of contacts. Target address information corresponding to the identified portrait may be acquired from the contact information database. This technical solution enables speedy and accurate identification of target address associated with a person appearing in the target image and facilitates the subsequent automatic transmission of the target image to the target address.

In some implementation, in the image transmission method provided in the above embodiment, the target address information of the contact associated with the personal characteristic information includes any one of: a target account and a phone number. The embodiment of the present disclosure does not limit the particular representation of the target address information.

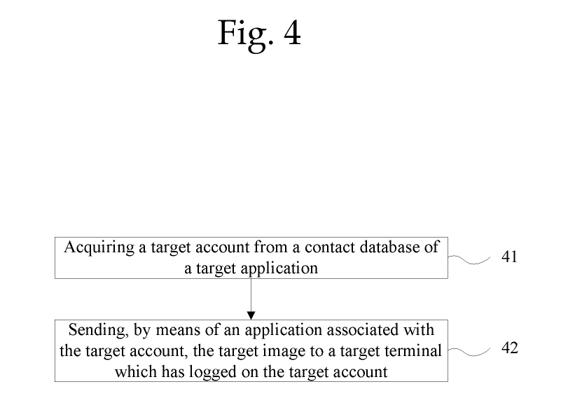

FIG. 4 is a flowchart of another implementation of step 13 of FIG. 1, as an alternative to the implementation of FIG. 2. This implementation is applicable to either a mobile terminal or a server. Specifically, the target address information of FIG. 2 may include a target account information, such as an email account or a social network account. Thus, an application associated with the account may be invoked to transmit the target image to a terminal that has logged into the target account. The owner of the target account may thus access the transmitted target image on his/her terminal automatically if he/she has logged into the target account.

In step 41 (an alternative of step 21), the target account is acquired from a contact database of an application.

Specifically, the embodiment of the present disclosure is described mainly by taking an example where image transmission is accomplished by means of an application, which can be a social network software such as a photo sharing application. In this embodiment, if the target address information is a target account, this target account needs to be first acquired from the contact database of the application.

In step 42 (an alternative of step 22), the target image is sent by the application to a terminal which has logged into the target account.

If the target address information of the contact associated with the personal characteristic information is a target account of a target application and the target account has been acquired, the target application can be used to send the target image to a target terminal which has logged on the target account. Thus, any target terminal which has logged on this target account can receive the target image, and the implementation is simple.

Thus, in the image transmission method provided in the embodiment of FIG. 4, the target address information may include a target account, and the target account can be acquired from a contact database of an application associated with the target account, and then the target image can be sent by the application to a target terminal which has logged on this target account. The application may be a communication platform for contacts to perform information interaction. It can rapidly locate the target account of the contact associated with the personal characteristic information according to the personal characteristic information in the target image, and then automatically send the target image directly to the target terminal which has logged on the target account after acquiring the target image, thereby solving the problem of omitting to send an image due to a delay of the sending, improving the timeliness of image transmission, and improving convenience of a user's operation.

In some implementation, the image transmission method provided in the above embodiment may be implemented by a mobile terminal or a combination of a mobile terminal and a server. In the following embodiment, description is made by taking an example where the image transmission method is applied to a mobile terminal.

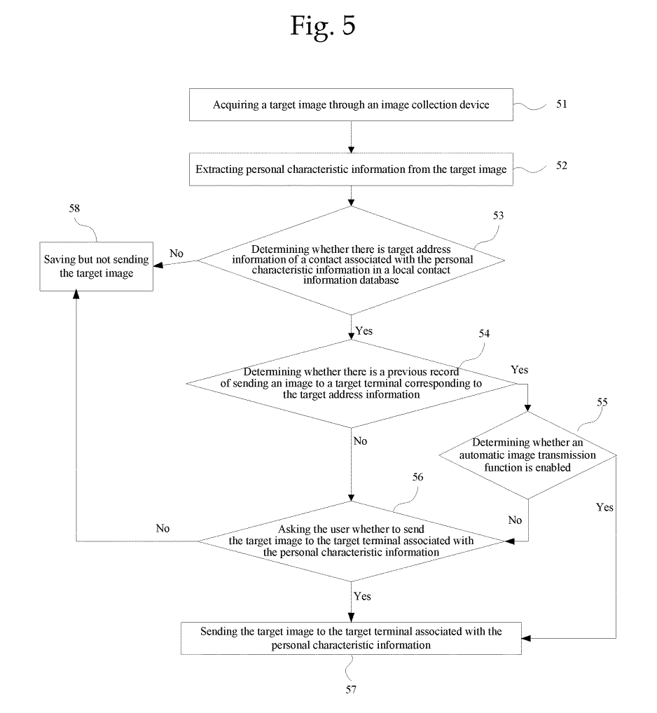

FIG. 5 is a flowchart of an image transmission method according to yet another exemplary embodiment. The image transmission method may include the following steps.

In step 51, a target image is acquired through an image collection device.

In step 52, personal characteristic information is extracted from the target image.

In step 53, it is determined whether there is target address information of a contact associated with the personal characteristic information in a local contact information database. If yes, step 54 is performed; otherwise, step 58 is performed.

As an example, if the personal characteristic information is facial characteristic information, the facial characteristic information can be recognized by using a geometry-based human face recognition method, that is, according to the shapes of the eyes, the mouth, the nose and so on in a human face and the geometrical relationship among them. Alternatively, the facial characteristic information recognition can be done through the use of a PCA-based (Principle Component Analysis based) human face recognition method, a neural network human face recognition method or an elastic matching human face recognition method. Upon recognition of human facial characteristic information in the target image, the mobile terminal determines whether there is target address information of a contact associated with the recognized facial characteristic information in the local contact information database.

In this embodiment, the facial characteristic information is compared with stored contact portrait in the local contact information database, and it is determined whether there is target address information for a contact associated with the facial characteristic information in the local contact information database. If it is determined that there is target address information of a contact associated with the facial characteristic information in the local contact information database, the process proceeds to step 54, in which it is determined whether there is a previous record of sending an image to a target terminal corresponding to the target address information in the mobile terminal. If it is determined that there is no target address information associated with the facial characteristic information in the local contact information database, the target image is simply stored for the user to determine subsequently whether or not to send the image. That is, the process proceeds to step 58.

In step 54, it is determined whether there is a previous record of sending an image to a target terminal corresponding to the target address information. If yes, step 55 is performed; otherwise, step 56 is performed.

If the mobile terminal determines that there is a record of sending an image to the target terminal corresponding to the target address information, it indicates that the mobile terminal previously sent an image to the target terminal associated with the personal characteristic information. Therefore, when a target image containing the same personal characteristic information is acquired again, the mobile terminal automatically sends the target image to the target terminal associated with the personal characteristic information. Otherwise, it needs to ask the user whether to send the image.

In step 55, it is determined whether an automatic image transmission function is enabled. If yes, step 57 is performed; otherwise, step 56 is performed.

The mobile terminal allows the user to enable or disable the automatic image transmission function. Therefore, when the automatic image transmission function is enabled and the mobile terminal determines that there is a previous record of sending an image to the target terminal corresponding to the target address information, the target image can be sent to the target terminal associated with the personal characteristic information. However, when the automatic image transmission function is not enabled, even though the mobile terminal judges that there is a previous record of sending an image to the target terminal corresponding to the target address information, it needs to ask the user whether to send the target image to the target terminal associated with the personal characteristic information. Then, it is determined whether or not to share the target image according to the user's response.

If the automatic image transmission function is enabled and the mobile terminal determines that there is a previous record of sending an image to the target terminal corresponding to the target address information, the appropriate application of the mobile terminal is invoked in the present disclosure to automatically send the target image to the target terminal associated with the personal characteristic information, which simplifies operations for image transmission and improves user experience.

In step 56, the user is asked whether to send the target image to the target terminal associated with the personal characteristic information. If yes, the process proceeds to step 57; otherwise, step 58 is performed.

If there is no previous record of sending an image to the target terminal corresponding to the target address information, the mobile terminal sends out a query, asking the user whether to allow a one-time transmission of the target image and/or whether to allow automatic sending if a target image containing the personal characteristic information is acquired in the future. If the user allows sending the target image to the target terminal associated with the personal characteristic information, the mobile terminal sends the target image to the target terminal associated with the personal characteristic information. Otherwise, the transmission of the target image is canceled and the target image is saved without being transmitted.

In step 57, the target image is sent to a target terminal associated with the personal characteristic information.

In this step and in a scenario where the user previously allowed sending a target image containing personal characteristic information to a target terminal associated with the personal characteristic information (that is, there is an image transmission record in the mobile terminal), another target image containing the same personal characteristic information will be automatically sent to the target terminal associated with the personal characteristic information when the mobile terminal acquires the target image, as long as the automatic transmission option is set.

In step 58, the target image is saved but not sent.

Specifically, since the user does not allow sending of the target image, the mobile terminal only saves the target image.

Thus, in the image transmission method provided in FIG. 5, personal characteristic information in a target image is acquired; it is determined whether there is target address information of a contact associated with the personal characteristic information in a local contact information database; when there is target address information of a contact associated with the personal characteristic information in the local contact information database, it is further determined whether there is any previous record of sending an image to a target terminal corresponding to the target address information; and when there is a previous image transmission record, the target image is sent to the target terminal associated with the personal characteristic information. In the technical solution of the present disclosure, by determining whether there is any previous record of sending an image to the target terminal corresponding to the target address information and then determining whether automatic transmission is allowed, the level of difficulty for sending images between mobile terminals is reduced. Image transmission between mobile terminals may be automated based on facial recognition. User experience is improved.

As an example, the above step 12 or 52 may be implemented by detecting whether there is personal characteristic information in a target image and extracting the personal characteristic information from the target image only if it is contained in the target image.

Specifically, after a mobile terminal acquires a target image, it may first detect whether there is any personal characteristic information in the target image. The mobile terminal extract personal characteristic information from the target image only if it determines that such personal characteristic information exists in the target image. Otherwise, the mobile terminal merely stores the target image.

It should be noted that the mobile terminal can be of any kind, such as a smart phone, a tablet computer, an MP3, a smart watch and so on, and can also be a Bluetooth headset, an MP5 and so on, which will not be enumerated here. The present disclosure does not limit a mobile terminal to any particular type.

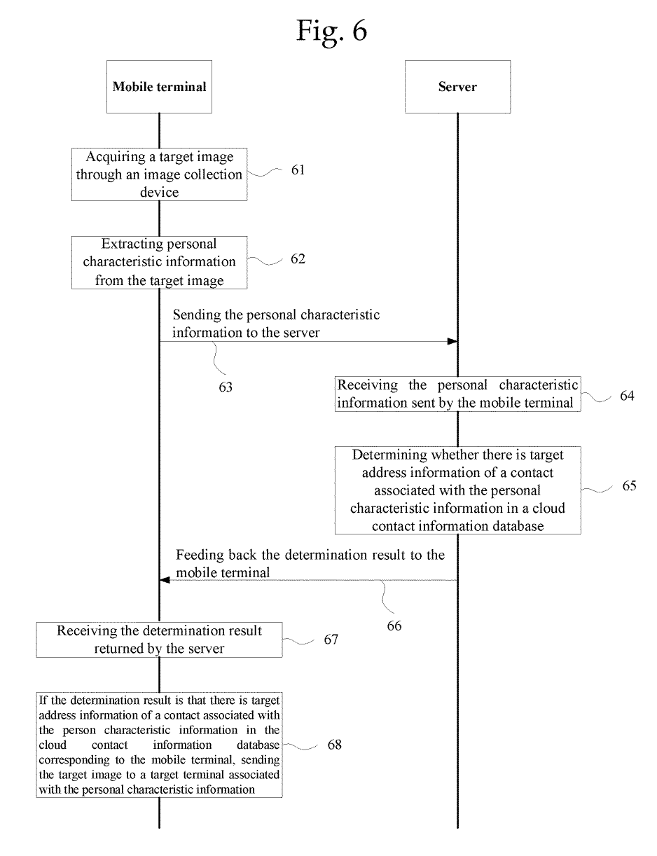

FIG. 6 is a schematic diagram showing an image transmission method between a mobile terminal and a server according to an exemplary embodiment. The image transmission method may include the following steps.

In step 61, the mobile terminal acquires a target image through an image collection device.

In step 62, the mobile terminal extracts personal characteristic information from the target image.

In step 63, the mobile terminal sends the personal characteristic information to the server.

Alternatively, when the mobile terminal is connected to a network, the extracted personal characteristic information is uploaded to a cloud server so that the server performs personal characteristic recognition using a corresponding recognition algorithm. For example, if the personal characteristic information is facial characteristic information, the facial characteristic information will be recognized using a human face recognition algorithm performed on portraits for contacts in the cloud server, so as to determine whether there is target address information of a contact associated with the personal characteristic information in a cloud contact information database.

In step 64, the server receives the personal characteristic information sent by the mobile terminal.

The server, also referred to as servo, is a device for providing computing service, and can carry out processing in response to service requests from the mobile terminal. Therefore, in this embodiment, the server can receive the personal characteristic information sent by the mobile terminal and recognize the personal characteristic information among the portraits for contacts stored in the server.

In step 65, the server determines whether there is target address information of a contact associated with the personal characteristic information in a cloud contact information database.

Generally, the server stores contact data of the mobile terminal, that is, relevant contacts of the mobile terminal are synchronized to the server. Therefore, when the server receives the personal characteristic information of the target image, it can perform comparison of the personal characteristic information under the control of its processor and provide a determination result regarding whether there is target address information of a contact having a portrait associated with the personal characteristic information derived from the target image in the cloud contact information database.

In step 66, the server feeds back the determination result to the mobile terminal.

The server feeds back the determination result to the mobile terminal, so that the mobile terminal can perform subsequent processing on the target image according to the determination result.

In step 67, the mobile terminal receives the determination result returned by the server.

The determination result may be that there is target address information of a contact associated with the personal characteristic information in the cloud contact information database corresponding to the mobile terminal. Alternatively, the determination result may be that there is no target address information of a contact associated with the personal characteristic information in the cloud contact information database corresponding to the mobile terminal.

In step 68, the mobile terminal sends the target image to the target terminal associated with the personal characteristic information, if the determination result is that there is target address information of a contact associated with the personal characteristic information in the cloud contact information database corresponding to the mobile terminal.

Alternatively, if the judgment result is that there is no target address information of a contact associated with the personal characteristic information in the cloud contact information database corresponding to the mobile terminal, the target image is stored but not shared.

Thus, in the image transmission method provided in this embodiment of FIG. 6, a mobile terminal acquires a target image, extracts personal characteristic information from the target image, and sends the personal characteristic information to a server. After receiving the personal characteristic information sent by the mobile terminal, the server determines whether there is target address information of a contact having a portrait associated with the personal characteristic information in a cloud contact information database, and feeds back the determination result to the mobile terminal. The mobile terminal determines whether to send the image according to the determination result. As such, the accuracy of recognition of personal characteristic information is improved. Transmission of target images between mobile terminals may be automated. User experience is improved.

Alternatively, in the embodiment shown in FIG. 6, after the mobile terminal receives the determination result returned by the server, and if the determination result is that there is target address information of a contact associated with the personal characteristic information in the cloud contact information database corresponding to the mobile terminal, then the mobile terminal may further determine whether there is a previous record of sending an image to a target terminal corresponding to the target address information and whether the automatic image transmission function is enabled, and performs corresponding steps according those described in FIG. 5.

The following is apparatus embodiments of the present disclosure which can be used to execute the method embodiments of the present disclosure. As to details not disclosed in the apparatus embodiments of the present disclosure, reference can be made to the method embodiments of the present disclosure described above.

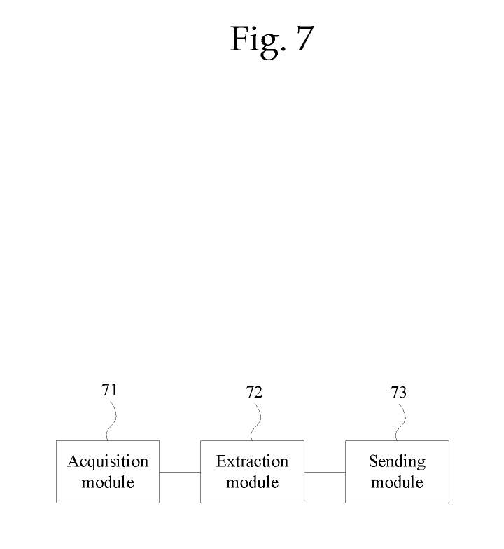

FIG. 7 is a block diagram of an image transmission apparatus according to an exemplary embodiment. The image transmission apparatus may be implemented in a mobile terminal or a server. They may be implemented entirely or in part as software, hardware or a combination thereof. As shown in FIG. 7, the image transmission apparatus includes an acquisition module 71, an extraction module 72 and a sending module 73.

The acquisition module 71 is configured to acquire a target image. For example, the acquisition module may comprise a camera.

The extraction module 72 is configured to extract personal characteristic information from the target image acquired by the acquisition module 71.

The sending module 73 is configured to send the target image to a target terminal associated with the personal characteristic information extracted by the extraction module 72.

The image transmission apparatus of FIG. 7 thus acquires a target image through the acquisition module 71, extracts personal characteristic information from the target image through the extraction module 72, and sends the target image to a target terminal associated with the personal characteristic information extracted by the extraction module 72 through the sending module 73. As such, the technical solution provided by the disclosed embodiment of FIG. 7 allows the target image to be sent automatically and with little delay after target image is acquired, improving user experience and operational convenience, and timeliness of the transmission of the target image to a target device or account belonging to a person having the identified personal characteristic information in the target image.

As an example, in the image transmission apparatus provided in the above embodiment, the acquisition module 71 may be configured to acquire the target image through an image collection device, such as a camera.

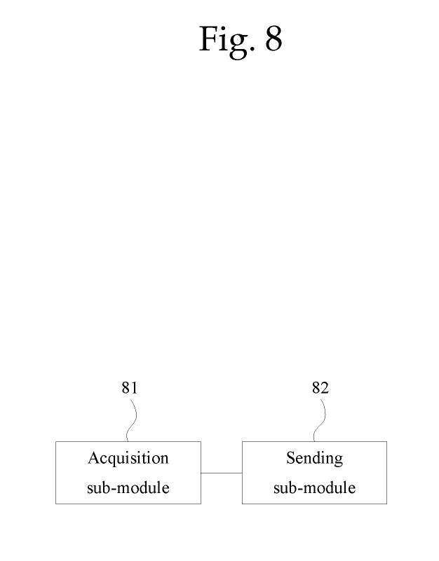

FIG. 8 shows an exemplary implementation of the sending module 73 of FIG. 7. Specifically, the sending module 73 may include an acquisition sub-module 81 and a sending sub-module 82.

The acquisition sub-module 81 is configured to acquire target address information of a contact associated with the personal characteristic information extracted by the extraction module 72.

The sending sub-module 82 is configured to send the target image to the target terminal according to the target address information acquired by the acquisition sub-module 81.

The image transmission apparatus provided in the embodiment of the present application may thus be used for performing the image transmission method shown in FIG. 1 and FIG. 2. The implementation and technical effect of the apparatus of FIGS. 7 and 8 are similar to those of the method of FIGS. 1 and 2. Description with regard to FIGS. 1 and 2 thus applies to FIGS. 7 and 8.

In one implementation, in the apparatus for sending an image provided in the above embodiment, the personal characteristic information further includes at least one of: apparel information, personal accessories information, and body figurative characteristic information.

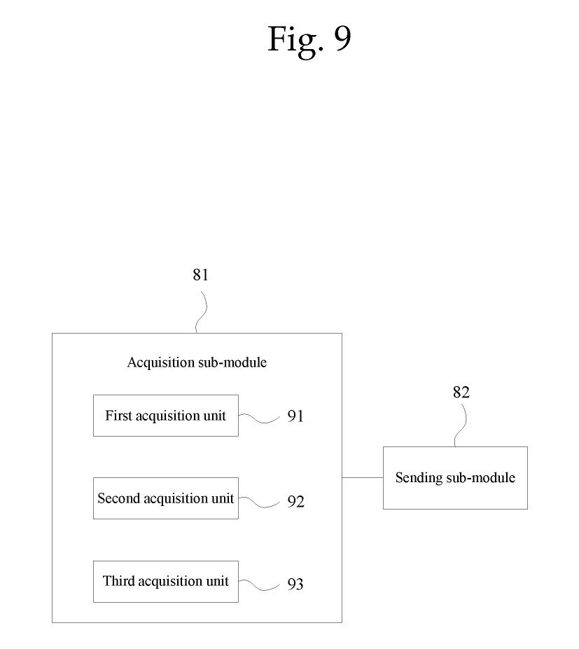

As an example, FIG. 9 is a block diagram of an image transmission apparatus according to still another exemplary embodiment. The image transmission apparatus may be implemented as a mobile terminal or server or part of it through software, hardware or a combination thereof. The embodiment of the present disclosure further describes the image transmission apparatus on the basis of the above embodiment. In the image transmission apparatus provided in the above embodiment, as shown in FIG. 9, if the personal characteristic information includes facial characteristic information, then the acquisition sub-module 81 includes a first acquisition unit 91, a second acquisition unit 92 and a third acquisition unit 93.

The first acquisition unit 91 is configured to access a contact information database which includes correspondences between head portrait information and address information of contacts.

The second acquisition unit 92 is configured to traverse the contact information database to acquire target head portrait information corresponding to the facial characteristic information.

The third acquisition unit 93 is configured to acquire target address information corresponding to the target head portrait information from the contact information database.

The image transmission apparatus provided in the embodiment of the present application is used for performing the technical solution of the image transmission method shown in FIG. 3. The implementation and technical effect of the apparatus are similar to those of the method, and will not be described here redundantly.

In one implementation, in the image transmission apparatus provided in the above embodiment, the target address information includes any one of: a target account and a phone number.

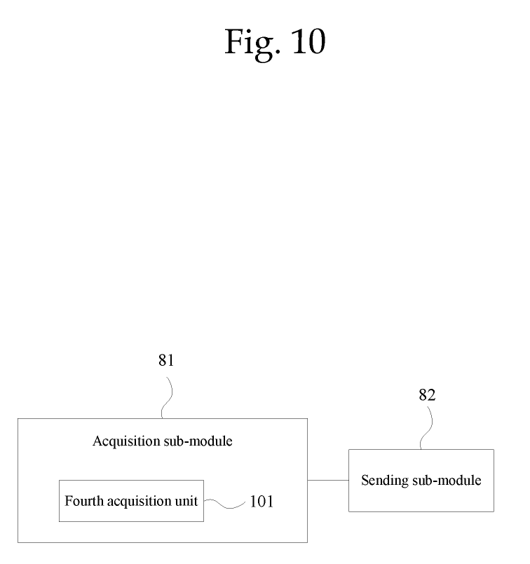

As an example, FIG. 10 is a block diagram of an image transmission apparatus according to yet another exemplary embodiment. The image transmission apparatus may be implemented as a mobile terminal or server or part of it through software, hardware or a combination thereof. The embodiment of the present disclosure further describes the image transmission apparatus on the basis of the above embodiment. In the image transmission apparatus provided in the above embodiment, as shown in FIG. 10, if the target address information includes a target account, then the acquisition sub-module 81 includes a fourth acquisition unit 101.

The fourth acquisition unit 101 is configured to acquire the target account from a contact database of an application.

The sending sub-module 82 is further configured to send, by means of the application, the target image to a target terminal which has logged on the target account.

The image transmission apparatus provided in the embodiment of the present application is used for performing the technical solution of the image transmission method shown in FIG. 4. The implementation and technical effect of the apparatus are similar to those of the method, and will not be described here redundantly.

As to the apparatus in the above embodiments, the specific manners for respective modules to perform operations have been described in detail in embodiments related to the methods, and will not be elaborated here.

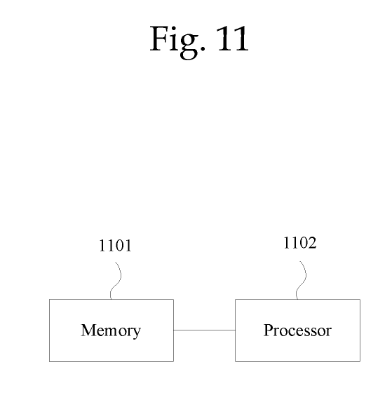

The foregoing describes the inner functional modules and schematic structures of the image transmission apparatus. FIG. 11 is a physical block diagram of an image transmission apparatus according to an exemplary embodiment. As shown in FIG. 11, the image transmission apparatus includes: a memory 1101 and a processor 1102.

The memory 1101 is configured to store instructions executable by the processor.

The processor 1102 is configured to: acquire a target image; extract personal characteristic information from the target image; and send the target image to a target terminal associated with the personal characteristic information.

It should be noted that, in the embodiment of the image transmission apparatus provided in FIG. 11, the processor may be a central processing unit (CPU) or any other general-purpose processor, a digital signal processor (DSP), an application specific integrated circuit (ASIC) and so on. The general-purpose processor may be a microprocessor or any other conventional processor and so on. The above memory may be a read-only memory (ROM), a random access memory (RAM), a flash memory, a hard disk or a solid state disk. A SIM card is also referred to as a subscriber identity card or smart card, and a digital mobile phone cannot be used until such a card is mounted in the mobile phone. That is, information on a user of the digital mobile phone, an encryption key and the user's phonebook and so on are stored in the computer chip. The steps of the method disclosed in the embodiments of the present disclosure may be directly executed by a hardware processor or by a combination of hardware of a processor and software modules.

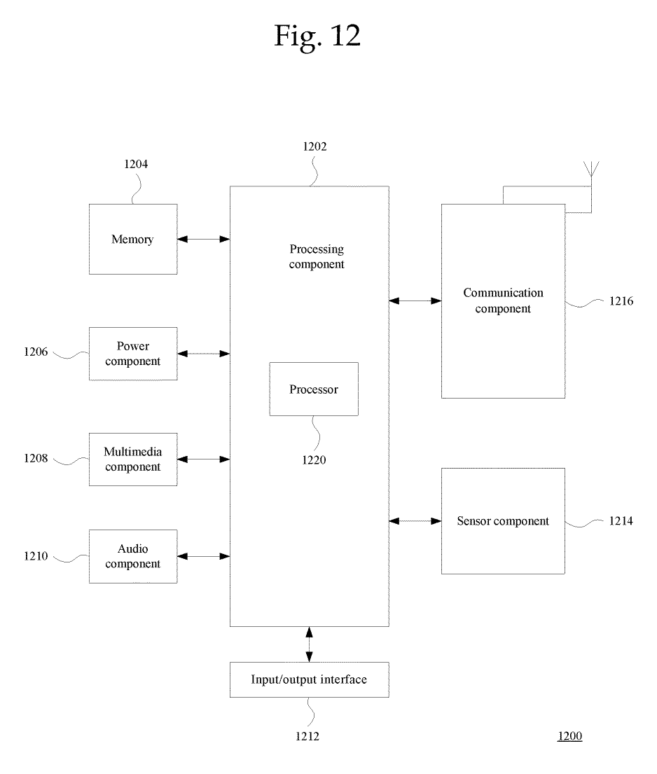

FIG. 12 is a block diagram of an image transmission apparatus according to an exemplary embodiment. For example, the apparatus 1200 may be a mobile phone, a computer, a digital broadcast terminal, a messaging device, a gaming console, a tablet, a medical device, exercise equipment, a personal digital assistant or the like.

Referring to FIG. 12, the apparatus 1200 may include one or more of the following components: a processing component 1202, a memory 1204, a power component 1206, a multimedia component 1208, an audio component 1210, an input/output (I/O) interface 1212, a sensor component 1214 and a communication component 1216.

The processing component 1202 generally controls the overall operations of the apparatus 1200, such as operations associated with display, phone call, data communications, camera operations and recording operations. The processing component 1202 may include one or more processors 1220 to execute instructions to perform all or part of the steps in the above described methods. In addition, the processing component 1202 may include one or more modules to facilitate the interaction between the processing component 1202 and other components. For example, the processing component 1202 may include a multimedia module to facilitate the interaction between the multimedia component 1208 and the processing component 1202.

The memory 1204 is configured to store various types of data to support the operations of the apparatus 1200. Examples of such data include instructions for any applications or methods operated on the apparatus 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the apparatus 1200. The power component 1206 may include a power supply management system, one or more power sources, and any other components associated with the generation, management, and distribution of power in the apparatus 1200.

The multimedia component 1208 includes a screen providing an output interface between the apparatus 1200 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1208 includes a front camera and/or a rear camera. The front camera and the rear camera may receive external multimedia data while the apparatus 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the apparatus 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the apparatus 1200. For instance, the sensor component 1214 may detect an open/closed status of the apparatus 1200, relative positioning of components, e.g., the display and the keypad, of the apparatus 1200, a change in position of the apparatus 1200 or a component of the apparatus 1200, a presence or absence of user contact with the apparatus 1200, an orientation or an acceleration/deceleration of the apparatus 1200, and a change in temperature of the apparatus 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor or a temperature sensor.

The communication component 1216 is configured to facilitate wired or wireless communication between the apparatus 1200 and other devices. The apparatus 1200 can access a wireless network based on a communication standard, such as Wi-Fi, 2G, 3G, LTE or 4G cellular technology or a combination thereof. In one exemplary embodiment, the communication component 1216 receives a broadcast signal or broadcast related information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an exemplary embodiment, there is also provided a non-transitory computer readable storage medium including instructions, such as included in the memory 1204, executable by the processor 1220 of the apparatus 1200, for performing the above-described methods. For example, the non-transitory computer-readable storage medium may be a ROM, a RAM, a CD-ROM, a magnetic tape, a floppy disc, an optical data storage device, and the like.

The non-transitory computer-readable storage medium stores executable instructions that, when executed by the processor of the apparatus 1200, cause the apparatus 1200 to execute the image transmission methods provided in the above various embodiments.

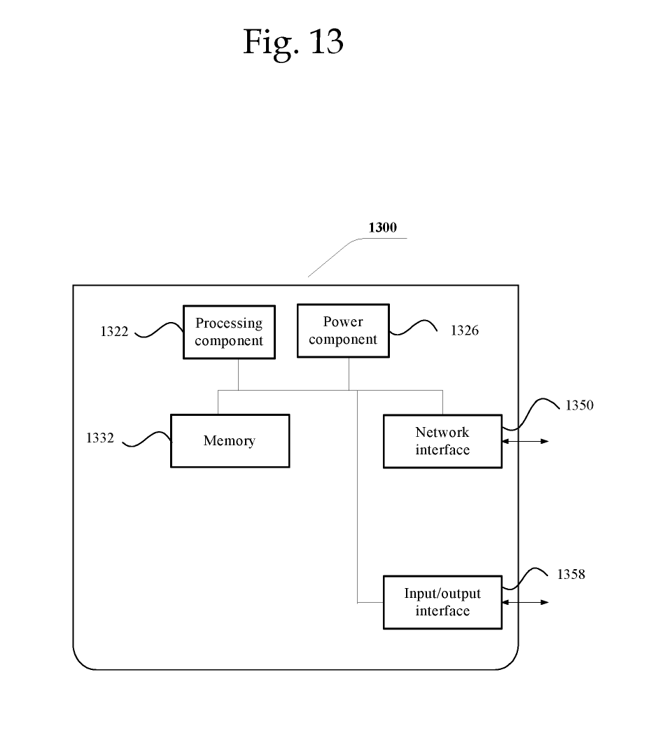

FIG. 13 is a block diagram of an image transmission apparatus according to an exemplary embodiment. For example, the apparatus 1300 may be provided as a server associated with a mobile terminal. Referring to FIG. 13, the apparatus 1300 includes a processing component 1322 which further includes one or more processors and memory resources represented by a memory 1332 for storing instructions executable by the processing component 1322, such as an application. The application stored in the memory 1332 may include one or more modules each corresponding to a group of instructions. In addition, the processing component 1322 is configured to execute instructions so as to execute the above-described image transmission method.

The apparatus 1300 may also include a power component 1326 configured to execute the power supply management of the apparatus 1300, one or more wireless network interfaces 1350 configured to connect the apparatus to a network and an input/output (I/O) interface 1358.

The apparatus 1300 may operate an operating system stored in the memory 1332, such as Windows Server™, Mac OS X™, Unix™, Linux™, FreeBSD™ or the like.

Each module or unit discussed above for FIGS. 7-11, such as the acquisition module, the extraction module, the sending module, the acquisition sub-module, the sending sub-module, the first acquisition unit, the second acquisition unit, the third acquisition unit, and the fourth acquisition unit may take the form of a packaged functional hardware unit designed for use with other components, a portion of a program code (e.g., software or firmware) executable by the processor 1220 or 1322 or the processing circuitry that usually performs a particular function of related functions, or a self-contained hardware or software component that interfaces with a larger system, for example.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and embodiments be considered as exemplary only, with a true scope and spirit of the present disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. An image transmission method, comprising:
acquiring an image using a first terminal device;
automatically extracting personal characteristic information from the acquired image;
automatically comparing the extracted personal characteristic information with a pre-existing contact information database; and
automatically sending the acquired image to a second terminal device associated with the extracted personal characteristic information.

2. The method according to claim 1, wherein acquiring the image comprises acquiring the image through an image collection device.

3. The method according to claim 1, wherein automatically comparing the extracted personal characteristic information with the pre-existing contact information database and sending the acquired image to the second terminal associated with the extracted personal characteristic information comprises:
automatically acquiring address information of the second terminal device for a contact associated with the personal characteristic information from the pre-existing contact information database; and
automatically sending the acquired image to the second terminal device according to the address information.

4. The method according to claim 3, wherein the personal characteristic information comprises facial characteristic information; and
wherein automatically acquiring the address information of the second terminal device for the contact associated with the personal characteristic information comprises:
automatically accessing the contact information database which comprises correspondences between portraits and address information of contacts;
automatically acquiring from the contact information database a portrait corresponding to the facial characteristic information; and
automatically acquiring address information corresponding to the acquired portrait from the contact information database as the address information of the second terminal device.

5. The method according to claim 4, wherein the personal characteristic information further comprises at least one of apparel information, personal accessory information, and body figurative characteristic information.

6. The method according to claim 3, wherein the acquired address information comprises one of an account information and a phone number.

7. The method according to claim 3, wherein the acquired address information comprises an account information;
wherein automatically acquiring the address information of the second terminal device for the contact associated with the personal characteristic information comprises automatically acquiring the account information from the contact database of an application associated with the account; and
wherein automatically sending the acquired image to the second terminal device according to the address information comprises automatically sending, by means of the application associated with the account, the acquired image to the second terminal device which has logged on the account.

8. An image transmission apparatus, comprising:
a processor;
a memory in communication with the processor for storing instructions executable by the processor;
wherein the processor, when executing the instructions, is configured to:
acquire an image;
automatically extract personal characteristic information from the acquired image; and
automatically send the acquired image to a terminal device associated with the extracted personal characteristic information.

9. The image transmission apparatus of claim 8, wherein the processor, when to acquire the image, is configured to acquire the image through an image collection device.

10. The image transmission apparatus of claim 8, wherein the processor, when to automatically send the acquired image to the terminal device associated with the extracted personal characteristic information, is configured to:
automatically acquire address information of the terminal device for a contact associated with the personal characteristic information; and
automatically send the acquired image to the terminal device according to the address information.

11. The image transmission apparatus of claim 10, wherein the personal characteristic information comprises facial characteristic information; and
wherein the processor, when to automatically acquire the address information of the terminal device for the contact associated with the personal characteristic information, is configured to:
automatically access a contact information database which comprises correspondences between portraits and address information of contacts;
automatically acquire from the contact information database a portrait corresponding to the facial characteristic information; and
automatically acquire the address information corresponding to the acquired portrait from the contact information database.

12. The image transmission apparatus of claim 11, wherein the personal characteristic information further comprises at least one of apparel information, personal accessory information, and body figurative characteristic information.

13. The image transmission apparatus of claim 10, wherein the acquired address information comprises one of an account information and a phone number.

14. The image transmission apparatus of claim 10, wherein the acquired address information comprises an account information:
wherein the processor, when to automatically acquire the address information of the terminal device for the contact associated with the personal characteristic information, is configured to automatically acquire the account information from a contact database of an application associated with the account; and
wherein the processor, when to automatically send the acquired image to the terminal device according to the address information, is configured to automatically send, by means of the application associated with the account, the acquired image to the terminal device which has logged on the account.

15. A non-transitory computer-readable storage medium having stored therein instructions that, when executed by a processor of a mobile terminal, causes the mobile terminal to:
acquire an image;
automatically extract personal characteristic information from the acquired image; and
automatically send the acquired image to a terminal device associated with the extracted personal characteristic information.

16. The storage medium of claim 15, wherein the instructions, when executed by the processor to acquire the image, causes the mobile terminal to acquire the image through an image collection device.

17. The storage medium of claim 15, wherein the instructions, when executed by the processor to automatically send the acquired image to the terminal device associated with the extracted personal characteristic information, causes the mobile terminal to:
automatically acquire address information of the terminal device for a contact associated with the personal characteristic information; and
automatically send the acquired image to the terminal device according to the address information.

18. The storage medium of claim 17, wherein the personal characteristic information comprises facial characteristic information; and
wherein the instruction, when executed by the processor to automatically acquire the address information of the terminal device for the contact associated with the personal characteristic information, causes the mobile terminal to:
automatically access a contact information database which comprises correspondences between portraits and address information of contacts;
automatically acquire from the contact information database a portrait corresponding to the facial characteristic information; and
automatically acquire the address information corresponding to the acquired portrait from the contact information database.

19. The storage medium of claim 18, wherein the personal characteristic information further comprises at least one of apparel information, personal accessory information, and body figurative characteristic information.

20. The storage medium of claim 17, wherein the acquired address information comprises one of an account information and a phone number.
